(19) United States
(12) Patent Application Publication
(10) Pub. No.: US 2023/0096566 A1
(43) Pub. Date: Mar. 30, 2023

(54) COLLABORATION SUPPORT SYSTEM, NON-TRANSITORY COMPUTER READABLE MEDIUM, AND COLLABORATION SUPPORT METHOD

(71) Applicant: FUJIFILM Business Innovation Corp., Tokyo (JP)

(72) Inventor: Yasushi AMANO, Kanagawa (JP)

(73) Assignee: FUJIFILM Business Innovation Corp., Tokyo (JP)

(21) Appl. No.: 17/711,456

(22) Filed: Apr. 1, 2022

(30) Foreign Application Priority Data
Sep. 24, 2021 (JP) 2021-155875

(51) Int. Cl. G06Q 10/10

(52) U.S. Cl. CPC G06Q 10/103

(57) ABSTRACT

A collaboration support system includes a first storage storing, as operation data, a copy of original data managed by an in-house system, a second storage storing a management table for managing an in-house manager, the operation data, and an external operator while associating the in-house manager, the operation data, and the external operator with a workplace that is a virtual external place for work, and a processor configured to: provide a workplace image indicating the workplace for the external operator on a basis of the management table; receive an operation performed by the external operator on the operation data after the external operator accesses the workplace; and update, if the in-house manager approves the operation, the original data by causing the original data to reflect the operation.

### CROSS-REFERENCE TO RELATED APPLICATIONS

This application is based on and claims priority under 35 USC 119 from Japanese Patent Application No. 2021-155875 filed Sep. 24, 2021.

### BACKGROUND

### (i) Technical Field

The present disclosure relates to a collaboration support system, a non-transitory computer readable medium, and a collaboration support method.

### (ii) Related Art

Collaborative work in which plural companies (may be individuals or companies run by a single person) cooperate with each other to carry out a project and outsourcing in which a part of a company's business is outsourced to another company are making progress. A term “collaboration” will be used herein to describe such forms of work in which plural parties are involved.

In collaboration, information safety is an issue. When an in-house system of a first company is to manage internal documents, for example, it would be problematic in terms of information safety to permit an operator belonging to a second company (can be seen as an external operator from a viewpoint of the first company) to access the internal documents directly.

With respect to this issue, Japanese Unexamined Patent Application Publication No. 2012-155392 discloses a mechanism where a server is provided outside a company, copies of necessary in-house data are saved to the server, and external operators use the copies. In this example of the related art, however, a specific configuration of the server provided outside the company and details of a service provided by the server, especially configurations for supporting collaborative work and securing information safety, are not described.

### SUMMARY

In collaboration, it would be problematic in terms of information security to permit external operators to directly access in-house data managed by an in-house system. The same problem occurs if in-house data reflects operations performed by external operators without any restrictions.

Aspects of non-limiting embodiments of the present disclosure relate to supporting collaboration by permitting external operators to use in-house data while securing safety of the in-house data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a collaboration support system including a first storage storing, as operation data, a copy of original data managed by an in-house system, a second storage storing a management table for managing an in-house manager, the operation data, and an external operator while associating the in-house manager, the operation data, and the external operator with a workplace that is a virtual external place for work, and a processor configured to: provide a workplace image indicating the workplace for the external operator on a basis of the management table; receive an operation performed by the external operator on the operation data after the external operator accesses the workplace; and update, if the in-house manager approves the operation, the original data by causing the original data to reflect the operation.

### BRIEF DESCRIPTION OF THE DRAWINGS

An exemplary embodiment of the present disclosure will be described in detail based on the following figures, wherein:

FIG. 1 is a block diagram illustrating a collaboration support system according to the exemplary embodiment;

FIG. 2 is a diagram illustrating a first example of the configuration of a workplace (WP) management table;

FIG. 3 is a conceptual diagram illustrating a configuration relating to a workplace;

FIG. 4 is a diagram illustrating functions of an approval process execution unit;

FIG. 5 is a diagram illustrating an example of a check support image;

FIG. 6 is a flowchart illustrating an example of operations performed by the collaboration support system;

FIG. 7 is a diagram illustrating a modification; and

FIG. 8 is a diagram illustrating a second example of the configuration of the WP management table.

### DETAILED DESCRIPTION

An exemplary embodiment will be described hereinafter on the basis of the drawings.

### (1) Outline of Exemplary Embodiment

A collaboration support system according to the exemplary embodiment includes a first storage unit, a second storage unit, and a processor. The first storage unit stores copies of original data managed by an in-house system as operation data. The second storage unit stores a management table for managing in-house managers, the operation data, and external operators while associating the in-house managers, the operation data, and the external operators with workplaces, which are virtual external places for work. The processor provides workplace images indicating the workplaces for the external operators on the basis of the management table. More specifically, when each of the external operators has performed an operation on operation data by accessing one of the workplaces, the processor receives the operation. In addition, when the in-house manager approves the operation, the processor updates the original data by reflecting the operation on the original data.

The operation data provided for the external operators is the copies of the original data. Even if an operation is performed on operation data, corresponding original data remains the same. An operation performed on operation data is not reflected on corresponding original data until an in-house manager approves the operation. With this mechanism, use of in-house data by external operators is facilitated while securing safety of the in-house data.

A workplace is a virtual place for external operators to work, and corresponds to a logical framework or unit for managing a project or data. One workplace may be allocated to one project, or plural workplaces (or plural sub-workplaces) may be allocated to one project.

A management table is generated and used in order to cause workplaces to function as virtual places for work and secure information safety. An in-house manager, operation data, external operators, and the like are managed on a management table for each workplace. For example, “in-house” refers to an area where login to an information processing system or a network in a company is required, and “external” refers to all other areas. Operation data may be document data, drawing data, table data, or the like. A “company” is a constituent of collaboration and has a broad concept herein. The concept can include an individual who conducts business, a company run by a single person, an organization, and a group.

In the exemplary embodiment, the processor provides, for an in-house manager in accordance with a request to update original data, a check support image for supporting a check on an operation. The in-house manager refers to the check support image and checks the operation. The in-house manager may issue the request to update original data, or another authorized person may issue the request to update original data, instead.

In the exemplary embodiment, the processor generates difference data indicating a difference between original data and data subjected to an operation as information indicating the operation. A check support image includes difference data. Difference data may be generated by identifying changes in data subjected to an operation. The processor may directly receive inputs or an operation performed by an external operator or receive data including an operation after an end of the operation.

In the exemplary embodiment, the processor checks an operation before providing the operation for an in-house manager. A result of the check is provided for the in-house manager along with information indicating the operation. The check may include a virus check, a format check, and the like. Automatic checks improve safety and reduce a burden on an in-house manager.

In the exemplary embodiment, a management table includes plural pieces of workplace information corresponding to plural workplaces. Each piece of the workplace information includes information for identifying an in-house manager, information for identifying operation data, and information for identifying external operators. Workplace information is thus used to cause workplaces to function as virtual places for work in order to carry out a project.

In the exemplary embodiment, each piece of the workplace information further includes information for identifying operation authority given to the external operators. The processor receives operations performed by the external operators on the basis of the information for identifying the operation authority. For example, addition of data and changes to data may be permitted, but removal and overwriting of data may be prohibited.

In the exemplary embodiment, information for identifying operation authority includes information indicating whether an operation for requesting update of original data is available. Whether an operation for requesting update of original data is available is managed for each external operator. Typically, an in-house manager or an in-house coordinator gives a request to update original data, but an external operator who has performed an operation may issue a request to update original data. An external operator may notify an in-house manager of completion of an operation, and the in-house manager may check the operation.

In the exemplary embodiment, the processor manages plural workplaces corresponding to plural external operators as plural sub-workplaces and provides plural sub-workplace images indicating the plural sub-workplaces for the external operators. For example, one sub-workplace may be allocated to each of the external operators who carry out a project. In this case, the plural sub-workplace collectively correspond to one workplace.

A program according to the exemplary embodiment is executed by an information processing apparatus and causes the information processing apparatus to function as the collaboration support system. The program has a function of managing data, a function of generating a table, a function providing images, a reception function, and an update function. The function of managing data is a function of managing copies of original data managed by the in-house system as operation data. The function of generating a table is a function of generating a management table for managing in-house managers, operation data, and external operators while associating the in-house managers, the operation data, and the external operators with workplaces, which are virtual external places for work. The function of providing images is a function of providing workplace images indicating workplaces for external operators on the basis of a management table. The reception function is a function of receiving an operation performed by an external operator on operation data after the external operator accesses a workplace. The update function is a function of updating original data by reflecting an operation approved by an in-house manager on original data.

The program is installed on the information processing apparatus via a network or a portable storage medium. The program is stored in a non-transitory storage medium in the information processing apparatus. The information processing apparatus may be a computer, a server, a collaboration support apparatus, a collaboration support system, or the like.

### (2) Details of Exemplary Embodiment

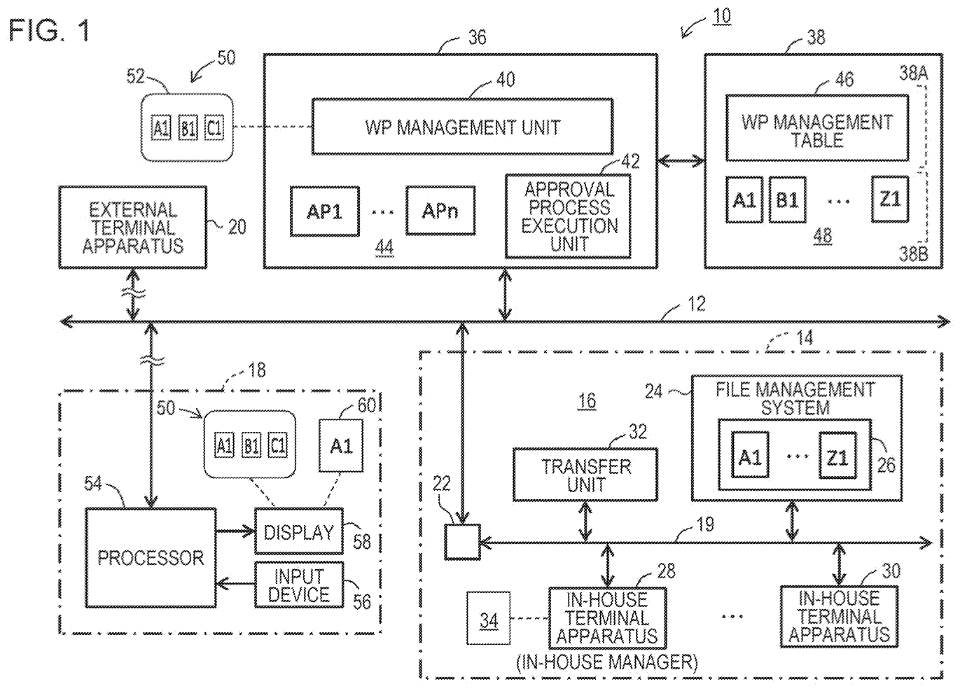

FIG. 1 illustrates the collaboration support system according to the exemplary embodiment. When a company and external operators (e.g., freelancers) cooperate together to carry out a project, the collaboration support system illustrated in FIG. 1 permits the external operators to use data belonging to the company (in-house data) while securing safety of the in-house data. The collaboration support system, however, may be used for various forms of collaboration.

The collaboration support system includes a workplace server 10. A workplace will also be abbreviated as “WP” hereinafter. The WP server 10 is connected to a network 12 such as the Internet. A company 14 includes an information processing system 16 as an in-house system. An in-house network 19 in the information processing system 16 is connected to the network 12 through a relay such as a bridge or a router. The network 12 can be seen as an external network from a viewpoint of the in-house network 19. External terminal apparatuses 18 and 20 are connected to the network 12. The external terminal apparatuses 18 and 20 are each used by an external operator.

The information processing system 16 includes a file management system 24, in-house terminal apparatuses 28 and 30, and a transfer unit 32, which are connected to the in-house network 19. The file management system 24 manages various files (in-house documents) and includes a storage 26. The storage 26 stores files A1 to Z1. These files can include various pieces of data such as document files, drawing files, and table files. Specific examples of a document file include a specification document and source code.

The in-house terminal apparatuses 28 and 30 are each achieved by a computer as an information processing apparatus. The computer includes a processor, an input device, and a display. In the example of the configuration illustrated in FIG. 1, an in-house manager uses the in-house terminal apparatus 28. The in-house manager is, for example, a person in charge of a project. As described later in detail, a check support image 34 is provided for the in-house manager in order to support a check on an operation performed by an external operator.

The transfer unit 32 operates in cooperation with the WP server 10. The transfer unit 32 generates a copy of a file selected in the storage 26 and transfers the copy to the WP server 10. The copy is an operation file on which external operators are to perform operations. In the example of the configuration illustrated in FIG. 1, the transfer unit 32 also functions as an update unit that reflects operations on an original file. From a viewpoint of the WP server 10, the transfer unit 32 corresponds to a local manager or an auxiliary module. The file management system 24 may function as the transfer unit 32, instead. The WP server 10 may achieve the function of the transfer unit 32. The transfer unit 32 is achieved, for example, by a computer.

In the example of the configuration illustrated in FIG. 1, the WP server 10 includes a processor 36 and a storage unit 38. The processor 36 is achieved by a central processing unit (CPU) that executes programs. The processor 36 provides plural functions. In FIG. 1, the functions are represented by different blocks. In the example of the configuration illustrated in FIG. 1, the processor 36 functions as a WP management unit 40, an approval process execution unit 42, and applications 44.

The WP management unit 40 is a module that provides a file service for external operators by managing workplaces that are virtual places for work. More specifically, the WP management unit 40 provides a workplace image indicating a workplace for the external terminal apparatuses 18 and 20, that is, the external operators, and receives operations performed in the workplaces on files or the like. The external operators access the workplace, identify files on which operations are to be performed, and perform operations on the files.

In FIG. 1, a workplace image 50 generated by the WP management unit 40 is schematically illustrated to the left of the processor 36. The workplace image 50 includes a workplace 52 corresponding to a display area, which includes icons indicating files.

The applications 44 are specifically applications (application programs) AP1 to APn. The applications AP1 to APn include a document creation application, a drawing creation application, and a table creation application. Operations are performed on the files using the applications AP1 to Apn. Operations may be performed on the files using applications installed on the external terminal apparatuses 18 and 20, instead.

The approval process execution unit 42 performs an approval process when an update request is issued with a specific file being specified. As described later, the approval process includes a series of steps such as automatic checks on an operation, generation of a check support image, provision of a check support image, and update of an original file.

The storage unit 38 is achieved by a storage device such as a semiconductor memory or a hard disk. In the example of the configuration illustrated in FIG. 1, the storage unit 38 stores a WP management table 46 and files 48. In the WP management table 46, information necessary to manage workplaces is registered. The files 48 are specifically files (copy files) A1 to Z1 generated by copying in-house files (original data). A first storage unit 38A storing the WP management table 46 and a second storage unit 38B storing the files 48 may be separately provided, instead. That is, the storage unit 38 may be achieved by plural storage devices.

The external terminal apparatus 18 includes a processor 54, an input device 56, and a display 58. The processor 54 is achieved by a CPU that executes programs. The input device 56 is achieved by a mouse, a keyboard, and/or the like. The display 58 is, for example, a liquid crystal display. The external terminal apparatus 20 has the same configuration as the external terminal apparatus 18.

When the external terminal apparatus 18 has accessed the WP server 10 and logged in a certain workplace, the display 58 displays the workplace image 50. the workplace image 50 includes the icons. When one of the icons is clicked, a file 60 opens and can be referred to. The display 58 may include a display area for displaying a workplace and a display area for displaying a file side-by-side or superimpose the display areas upon each other. One of these display methods may be selected.

For example, an external operator performs an operation, such as processing, on the file 60. Plural external operators may perform operations together on a certain file. An in-house operator and an external operator may perform operations together on a certain file.

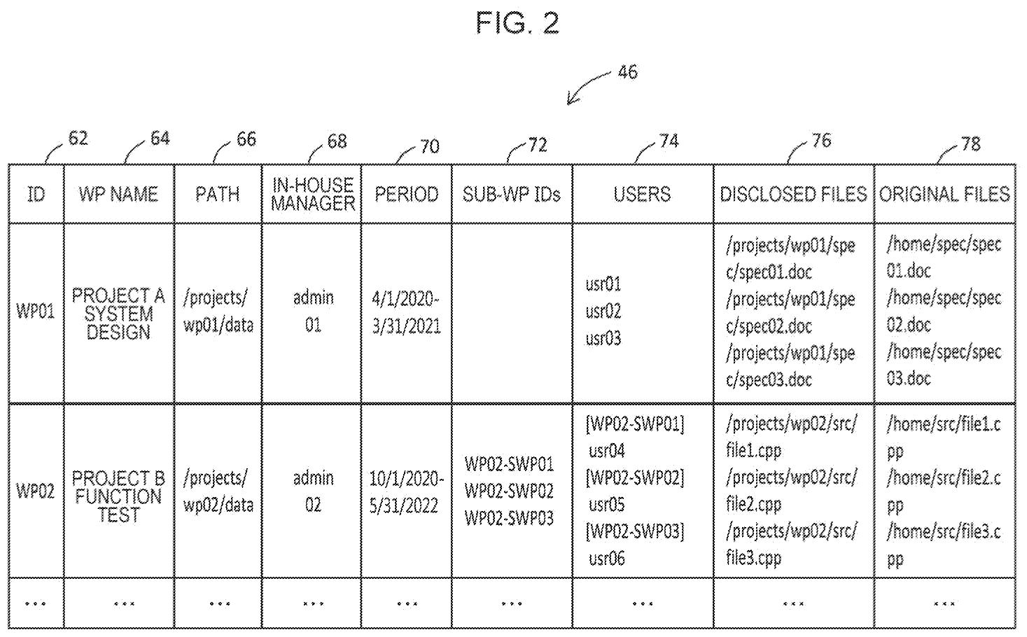

FIG. 2 illustrates a first example of the WP management table 46. The WP management table 46 includes plural pieces of workplace information corresponding to plural workplaces. Each piece of workplace information includes a workplace identifier (ID) 62, a workplace name 64, a path 66, information 68 for identifying an in-house manager, a workplace valid period 70, sub-workplace IDs 72, information 74 for identifying users, information 76 for identifying disclosed files, and information 78 for identifying original files.

The path 66 is used to access a workplace. The information 68 for identifying an in-house manager is information, such as an ID of a person in charge of a project, for, when an operation has been performed on a file associated with a workplace, identifying a person who has authority to approve reflection of the operation on an original file. Plural in-house managers may be associated with one workplace. When plural sub-workplaces are allocated to plural external operators who are participating in a project, for example, plural sub-workplace IDs are registered.

The information 74 for identifying users is one or plural user IDs for identifying one or plural users who can perform operations on one or plural files associated with a workplace. The information 76 for identifying disclosed files is information for identifying one or plural copy files disclosed through a workplace. The information 78 for identifying original files is information for identifying one or plural original files of one or plural copy files.

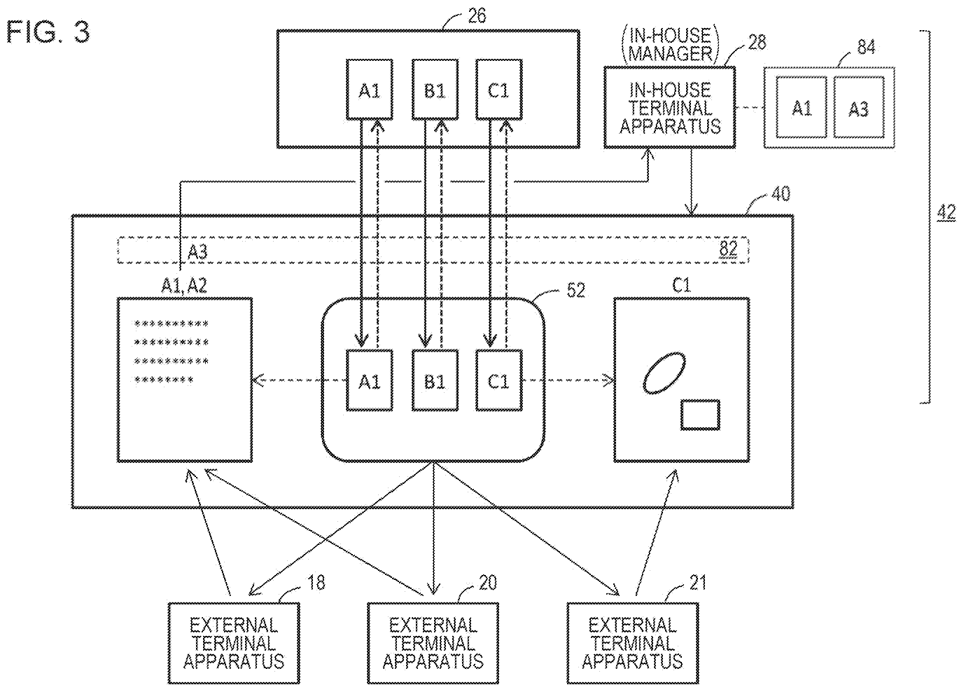

FIG. 3 schematically illustrates a configuration relating to the workplace 52. Original files A1, B1, and C1 relating to a certain project (hereinafter referred to as “project α”) are stored in the storage 26. Three operation files are generated on the basis of these files as three copy files under management of the WP management unit 40. The three operation files are managed in the workplace 52 corresponding to project α. In FIG. 3, labels A1, B1, and C1, which are given to the three original files, are also given to the three operation files, respectively.

The external terminal apparatuses 18, 20, and 21 are used by the external operators who carry out project α. By accessing the workplace 52, the operation files A1, B1, and C1 become available to the external terminal apparatuses 18, 20, and 21. When an icon indicating the operation file A1 is clicked, for example, the operation file A1 opens. As a result, the operation file A1 becomes available to the external terminal apparatuses 18 and 20. Similarly, when the operation file C1 is clicked, the operation file C1 opens. The operation file C1 becomes available to the external terminal apparatus 21.

When an operation is performed on the operation file A1, an operation file A2 that reflects the operation is generated. The approval process execution unit 42 conducts automatic checks and generates a check support image, which is indicated by a reference numeral 82.

Before an in-house manager checks an operation, automatic checks are conducted on the operation check A2. The automatic checks include an automatic security test and an automatic format test. The automatic security test is, for example, a virus check, and the automatic format test is, for example, a format check, and/or a word check.

A check support image including an operation file A3 subjected to automatic checks is generated and provided for the in-house terminal apparatus 28. A check support image 84 is displayed on a display of the in-house terminal apparatus 28. In the example illustrated in FIG. 3, the check support image 84 includes a copy file A1 and a file A3 subjected to a check. An operation can be identified by comparing these files. Parts corresponding to an operation may be displayed in a mode different from one for other parts. If the in-house manager approves the operation, the WP management unit 40 causes the original file in the storage 26 to reflect the operation. That is, the WP management unit 40 updates the original file A1. The same process is performed on the files B1 and C1, too.

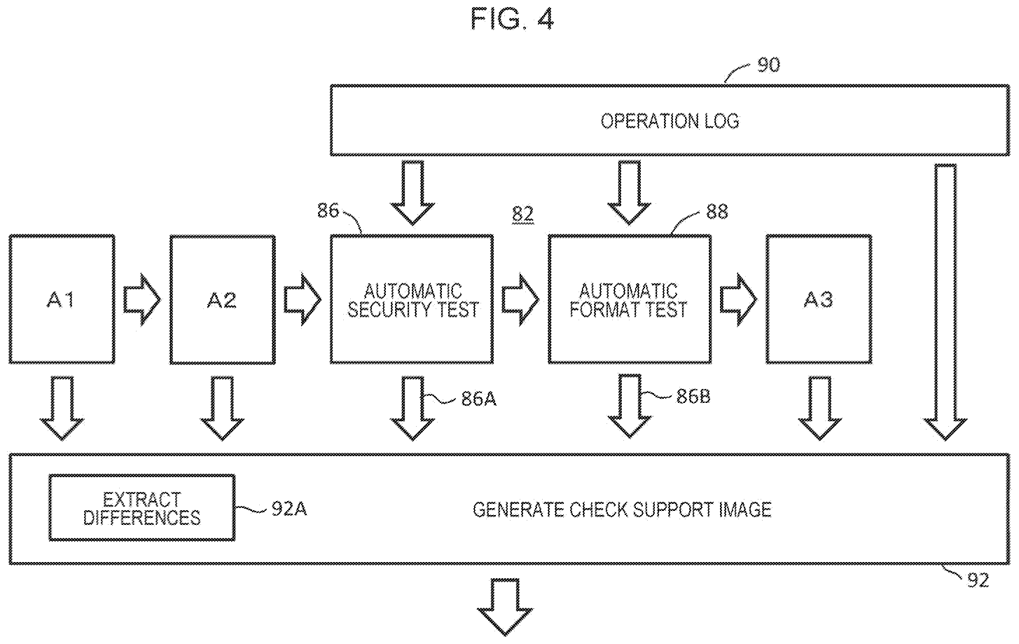

FIG. 4 schematically illustrates the functions achieved by the approval process execution unit 42. A file A2 subjected to a check is generated by adding data to or changing data in an operation file A1. An automatic security test 86 is conducted on the file A2, and then an automatic format test 88 is conducted. An operation log 90 generated by recording a series of operations in the past may be referred to during the tests 86 and 88.

A check support image is generated on the basis of a file A3 subjected to the tests 86 and 88 as indicated by a reference numeral 92. The check support image includes the file A3 subjected to the tests 86 and 88. As indicated by a reference numeral 92A, difference information may be extracted between the files A1 and A2 and included in the check support image. Difference information to be included in the check support image may be extracted between the files A1 and A3, instead. The check support image includes a result 86A of the automatic security test 86 and a result 86B of the automatic format test 88. The check support image may include the entirety or a part of the operation log 90.

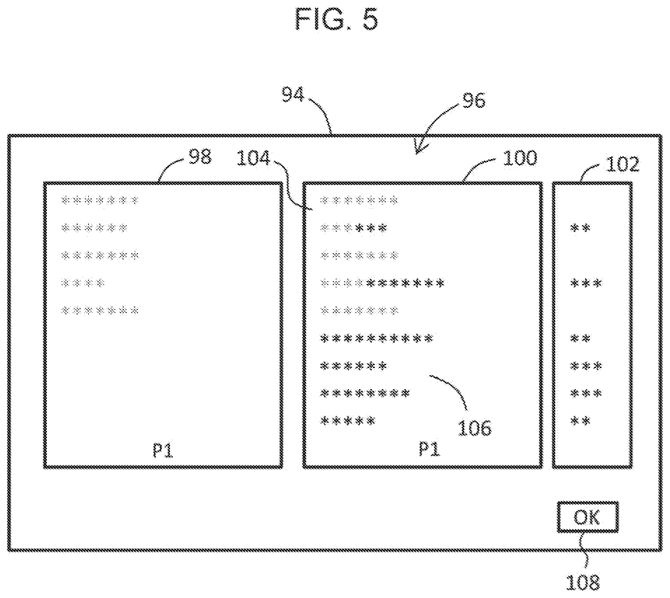

FIG. 5 illustrates an example of a check support image 96 displayed on a screen 94 of the display. The check support image 96 includes a file 98 before an operation and a file 100 after the operation. In the file 100 after the operation, parts shown in gray correspond to content 104 before the operation, and parts 106 shown in black correspond to content added or changed during the operation. The parts 106 correspond to the difference information. In a guidance 102, information for identifying a type of operation and results of automatic tests. A button 108 is used to give approval.

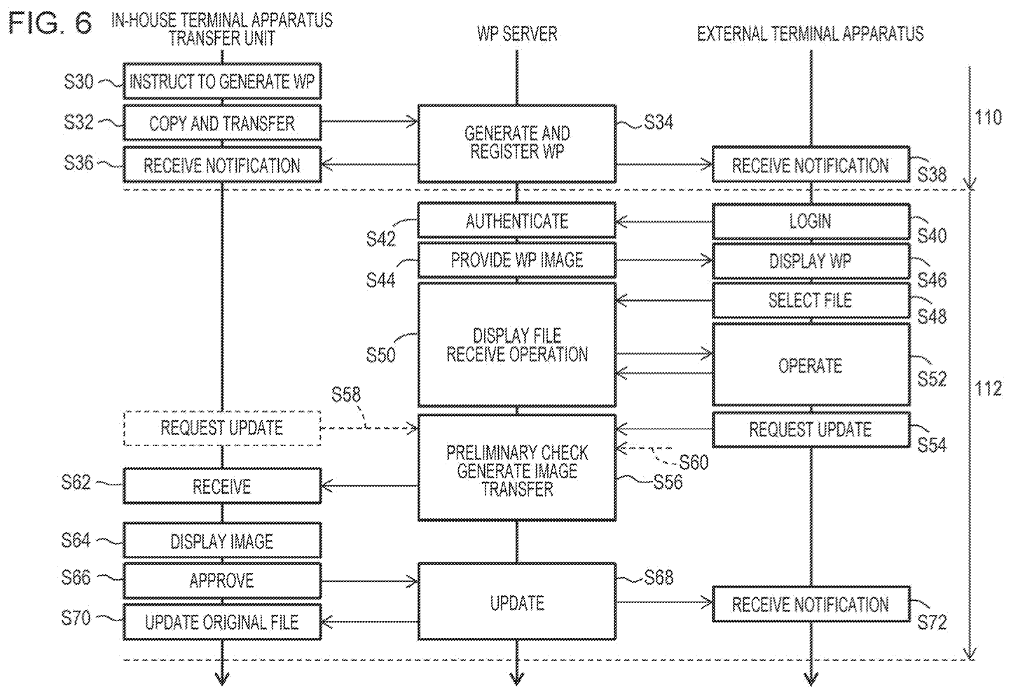

FIG. 6 is a flowchart illustrating operations performed by an in-house terminal apparatus and a transfer unit, operations performed by a WP server, and operations performed by an external terminal apparatus. The illustrated in-house terminal apparatus is used by an in-house manager. The illustrated external terminal apparatus is used by an external operator.

In S30, the in-house manager inputs an instruction to generate a workplace to the in-house terminal apparatus. In S32, the transfer unit copies a file identified by the instruction to generate a workplace, and a copy file is generated. The copy file is transmitted to the WP server. In S34, the WP server generates a workplace. More specifically, the WP server generates workplace information and registers the workplace information to a WP management table. The workplace information includes information for identifying the in-house manager, information for identifying the file, and information for identifying the external operator, who is a user. After the workplace information is registered, the in-house manger and the external operator are notified of the generation of the workplace in S36 and S38, respectively.

In S40, the external terminal apparatus transmits login information to the WP server. If the external terminal apparatus or the external operator is successfully authenticated in S42, a WP image is generated and provided for the external terminal apparatus in S44. In S46, the WP image is displayed on a display of the external terminal apparatus. In S48, the external operator selects an icon included in the WP image to select a file. As a result, the file opens on the WP server, and an image indicating the file is provided for the external terminal apparatus. In S52, an operation is performed on the file. In S50, the WP server receives the operation. The file may be downloaded onto the external terminal apparatus, and an operation may be performed on the file, instead.

In the example illustrated in FIG. 6, the external operator generates an update request in S54 after completion of the operation. In S56, the WP server conducts automatic checks on the file subjected to the operation, and a check support image is then generated. The check support image is transferred to the in-house terminal apparatus. As in S58, the in-house terminal apparatus may issue the update request, or as in S60, another terminal apparatus may issue the update request, instead.

In S62, the in-house terminal apparatus receives the check support image, and in S64, the check support image is displayed. The in-house manager determines whether to approve the operation on the basis of the check support image. If the operation is approved in S66, the WP server conducts an update in S68. More specifically, a signal for instructing the transfer unit to conduct an update is output, and in S70, the transfer unit updates an original file. That is, the original file reflects the operation. In S72, the external terminal apparatus is notified of the update. The flowchart includes a WP preparation process 110 and a WP management process 112.

After the instruction to generate a workplace is input in S30, a change to the original file in the storage 26 may be prohibited. Alternatively, an in-house operator may be permitted to change the original file, and the original file after such a change may reflect an operation performed by the external operator retrospectively.

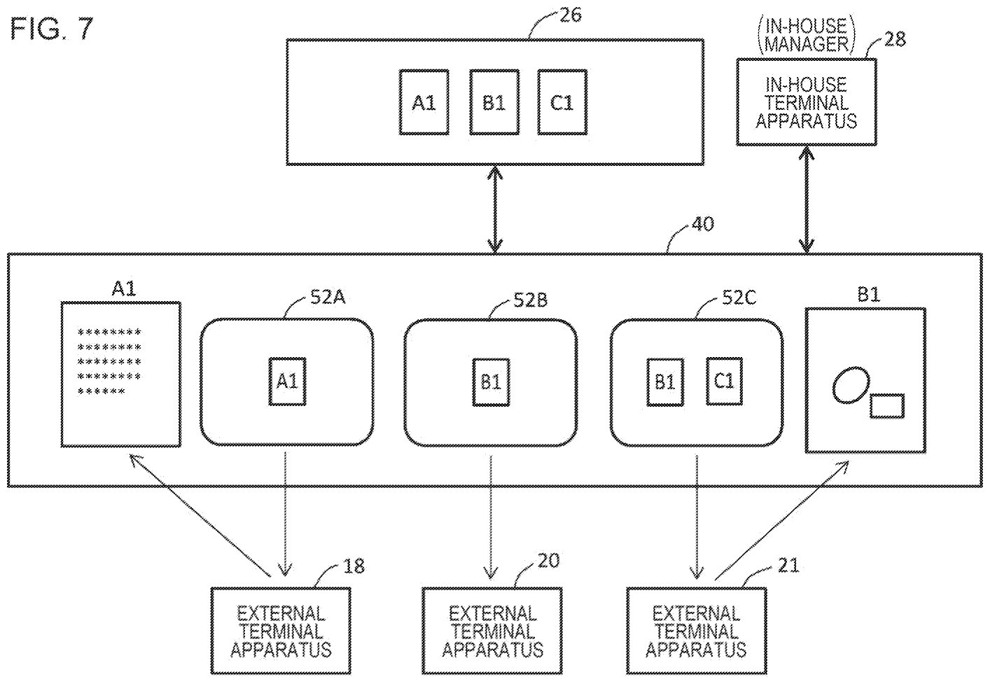

FIG. 7 illustrates a modification. In this modification, a workplace is divided into three sub-workplaces 52A, 52B, and 52C corresponding to three external operators, respectively. The WP management unit 40 is provided between the storage 26 and the external terminal apparatuses 18, 20, and 21. The in-house terminal apparatus 28 is connected to the WP management unit 40.

The sub-workplace 52A is a virtual place intended for an external operator A who uses the external terminal apparatus 18 and associated with only the file A1, on which the external operator A is to perform an operation. The sub-workplace 52B is a virtual place intended for an external operator B who uses the external terminal apparatus 20 and associated with only the file B1, on which the external operator B is to perform an operation. The sub-workplace 52C is a virtual place intended for an external operator C who uses the external terminal apparatus 21 and associated with the file B1 and a file C1, on which the external operator C is to perform an operation.

When sub-workplaces are used, an operation burden on each external operator, especially an operation target file of each external operator, can be clarified. An access valid period can be individually managed for each external operator by closing a corresponding workplace when an operation performed by the external operator ends.

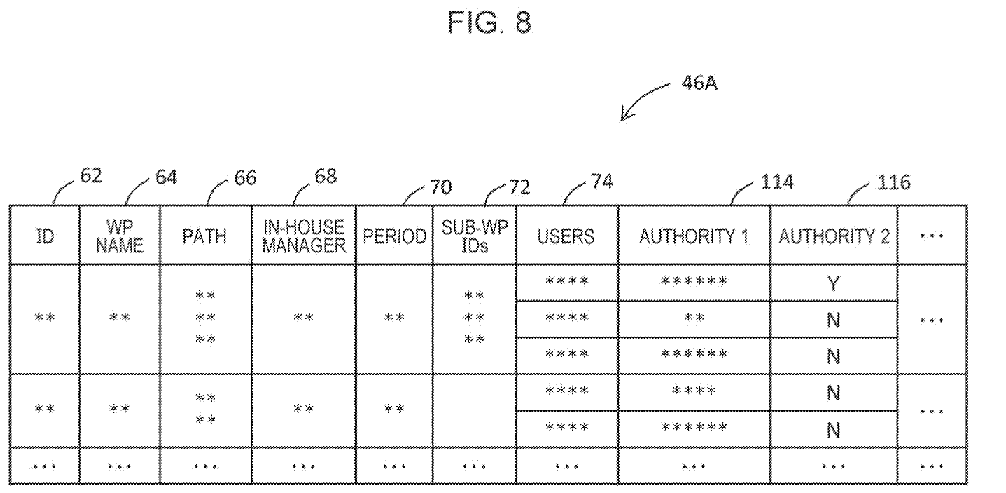

FIG. 8 illustrates a second example of the WP management table. In FIG. 8, the same items as in FIG. 2 are given the same reference numerals, and description thereof is omitted. A WP management table 46A includes plural pieces of workplace information corresponding to plural workplaces. Each piece of workplace information includes information 114 and 116 for identifying authority of external operators. In the example illustrated in FIG. 8, the information 114 is used to identify a type of operation that can be performed by each external operator. Examples of an acceptable operation include addition and change, and examples of a prohibited operation include deletion and overwriting. The information 116 indicates whether each external operator can give a request to update an original file.

For example, plural in-house managers may be provided for one workplace. In this case, an original file may be updated after all or any of the in-house managers has approved.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A collaboration support system comprising:
a first storage storing, as operation data, a copy of original data managed by an in-house system;
a second storage storing a management table for managing an in-house manager, the operation data, and an external operator while associating the in-house manager, the operation data, and the external operator with a workplace that is a virtual external place for work; and
a processor configured to:
provide a workplace image indicating the workplace for the external operator on a basis of the management table;
receive an operation performed by the external operator on the operation data after the external operator accesses the workplace; and
update, if the in-house manager approves the operation, the original data by causing the original data to reflect the operation.

2. The collaboration support system according to claim 1,
wherein the processor is configured to provide, for the in-house manager in accordance with a request to update the original data, a check support image for supporting a check on the operation.

3. The collaboration support system according to claim 2,
wherein the processor is configured to generate, as information indicating the operation, difference data indicating a difference between the original data and data subjected to the operation, and
wherein the check support image includes the difference data.

4. The collaboration support system according to claim 1,
wherein the processor is configured to:
check the operation before providing the operation for the in-house manager; and
provide information indicating the operation for the in-house manager along with a result of the check.

5. The collaboration support system according to claim 1,
wherein the management table includes a plurality of pieces of workplace information corresponding to a plurality of workplaces, and
wherein each of the plurality of pieces of workplace information includes information for identifying an in-house manager, operation data, and an external operator.

6. The collaboration support system according to claim 5,
wherein each of the plurality of pieces of workplace information also includes information for identifying operation authority given to the external operator, and
wherein the processor is configured to receive the operation performed by the external operator on a basis of the information for identifying the operation authority.

7. The collaboration support system according to claim 6,
wherein the information for identifying the operation authority includes information indicating whether a request to update the original data is available.

8. The collaboration support system according to claim 1,
wherein the processor is configured to:
manage a plurality of workplaces corresponding to a plurality of external operators as a plurality of sub-workplaces; and
provide a plurality of sub-workplace images indicating the plurality of sub-workplaces for the plurality of external operators.

9. A non-transitory computer readable medium storing a program causing a computer to execute a process for supporting collaboration, the process comprising:
managing, as operation data, a copy of original data managed by an in-house system;
generating a management table for managing an in-house manager, the operation data, and an external operator while associating the in-house manager, the operation data, and the external operator with a workplace that is a virtual external place for work;
providing a workplace image indicating the workplace for the external operator on a basis of the management table;
receiving an operation performed by the external operator on the operation data after the external operator accesses the workplace; and
updating, if the in-house manager approves the operation, the original data by causing the original data to reflect the operation.

10. A collaboration support method comprising:
storing, as operation data, a copy of original data managed by an in-house system;
storing a management table for managing an in-house manager, the operation data, and an external operator while associating the in-house manager, the operation data, and the external operator with a workplace that is a virtual external place for work;
providing a workplace image indicating the workplace for the external operator on a basis of the management table;
receive an operation performed by the external operator on the operation data after the external operator accesses the workplace; and
update, if the in-house manager approves the operation, the original data by causing the original data to reflect the operation.
